(19) United States
(12) Patent Application Publication
(10) Pub. No.: US 2010/0254333 A1
(43) Pub. Date: Oct. 7, 2010

(54) METHOD OF TRANSMITTING AND RECEIVING RANDOM ACCESS RESPONSE INFORMATION IN RADIO COMMUNICATION SYSTEM, AND BASE STATION AND TERMINAL THEREOF

(75) Inventors: Hyung Cheol Shin, Daejeon (KR); Jae-Heung Kim, Daejeon (KR); Mu Yong Shin, Daejeon (KR); Byung-Han Ryu, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTUTUTE, Daejeon (KR)

(21) Appl. No.: 12/746,094

(22) PCT Filed: Jun. 19, 2008
(86) PCT No.: PCT/KR08/03500

§ 371 Date: Jun. 3, 2010

(30) Foreign Application Priority Data
Dec. 6, 2007 (KR) 10-2007-0126275

(51) Int. Cl. H04W 72/00

(52) U.S. Cl. 370/329

(57) ABSTRACT

The present invention relates to a method of transmitting/receiving random access response information in a radio communication system, and a base station and a terminal thereof. According to the invention, in a case where a base station of a radio communication system transmits response information for random access processing requested from terminals, the base station determines whether to transmit non-contention-based response information and contention-based response information for each of one or more terminals, which requests random access, by one radio resource. When determining to be transmitted by one radio resource, the base station transmits the random access response information configured by the non-contention-based response information and the contention-based response information for each of one or more terminals. In addition, when determining to be transmitted by separate radio resources, the base station transmits the random access response information configured by the non-contention-based response information or the contention-based response information for each of one or more terminals. Accordingly, since the response information is efficiently configured from the point of view of allocation and utilization of radio resources, it can support variable and flexible utilization of physical layer radio resources.

### TECHNICAL FIELD

The present invention relates to a method of transmitting/receiving random access response information in a radio communication system, and a base station and a terminal thereof. Particularly, the present invention relates to execution of a random access procedure between a base station and a terminal in a cellular system for packet service.

The present invention derive from research that was performed as part of IT New Growth Engine Industries of Ministry of Information and Communication and Institute for Information Technology Advancement, Republic of Korea [Project-Management Number: 2005-S-404-13, Project Title: Research and Development of Radio Transmission Technology].

### BACKGROUND ART

In a known cellular system, random access response information is transmitted by using a dedicated channel or an associated exclusive channel.

An LTE (long term evolution; hereinafter referred to as “LTE”) system of which standardization work is in progress to provide various kinds of packet services is a packet based system and it is an object of the LTE system to provide a pure packet service, and efforts to find a more efficient and variable method of utilizing radio resources are being expended.

In order to allocate and utilize radio resources in a more adaptive way according to the wireless environment of terminals, a control channel that allows many terminals to share transmission of control information is considered rather than an dedicated control channel like a known WCDMA technique. In addition, it is considered to transmit some control information by radio resources allocated to terminals.

The LTE system that is currently being developed in 3GPP in order to provide various kinds of packet services is a packet based system, and the purpose of the LTE system is to provide a pure packet service.

Therefore, a configuration and transmission method of control information that is capable of supporting variable and flexible utilization of physical layer radio resources is requested.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention is to provide a method of transmitting/receiving random access response information in a radio communication system and a base station and a terminal thereof.

A technical object of the present invention is to provide a method of transmitting/receiving random access response information in a radio communication system that is capable of maximizing utilization of limited radio resources and that is capable of efficiently configuring random access response information transmitted from the base station to the terminal in downlink, and a base station and a terminal thereof.

### Technical Solution

In order to achieve the technical object of the present invention, a method of transmitting random access response information by means of a base station according to an exemplary embodiment of the present invention transmits response information for random access processing requested from terminals to the base station in a radio communication system, and the method includes: determining whether to transmit non-contention-based response information and contention-based response information for each of one or more terminals that request random access, by one radio resource; transmitting the random access response information configured by the non-contention-based response information and the contention-based response information for each of one or more terminals, when determining to transmit by one radio resource; and transmitting the random access response information configured by the non-contention-based response information or the contention-based response information for each of one or more terminals, when determining to transmit by separate radio resources.

A method of receiving random access response information by terminals according to another exemplary embodiment of the present invention receives response information for random access processing requested from terminals to the base station in a radio communication system, and the method includes: receiving random access response information from the base station, the random access response information including an information bit that indicates information on a mode of response information and the response information included therein, and at least one of the response information; extracting response information included in the random access response information by using the information bit included in the random access response information; and completing a random access response procedure by using the response information extracted from the random access response.

A base station according to still another exemplary embodiment of the present invention transmits response information for random access processing requested from terminals in a radio communication system, and the base station includes: a random access response generating section that generates random access response information according to whether to transmit non-contention-based response information and contention-based response information for each one or more terminals that requests random access, by one radio resource; and a random access response transmitting section that transmits random access response information configured by at least one of non-contention-based response information and at least one of contention-based response information, which are generated by the random access response generating section, or that transmits random access response information configured by at least one of non-contention-based response information or at least one of contention-based response information.

A terminal according to still another exemplary embodiment of the present invention receives response information for random access processing requested to a base station in a radio communication system, the terminal including: a random access response receiving section that receives random access response information including an information bit, which indicates information on a mode of response information and the response information included therein, and at least one of the response information from the base station; and a response information extracting section that extracts response information included in the random access response information by using the information bit included in the random access response information and completes a random access response procedure.

### ADVANTAGEOUS EFFECTS

According to the present invention, in a random access procedure of a cellular system for providing a packet service, it can efficiently configure the random access response information transmitted from the base station to the terminal in downlink and can transmit the random access response information by minimum radio resources. Therefore, it can maximize utilization of limited radio resources.

### BRIEF DESCRIPTION OF THE DRAWINGS

FIG. 1 is a flowchart illustrating a typical contention-based random access procedure to which the present invention is applied.

FIG. 2 is a block diagram illustrating the structures of a terminal and base station that execute the random access procedure according to an exemplary embodiment of the present invention.

FIG. 3 illustrates the format configuration of a random access response message according to a first exemplary embodiment of the present invention.

FIGS. 4 and 5 illustrate the format configurations of a random access response message according to a second exemplary embodiment of the present invention.

FIG. 6 is a flowchart illustrating a method of transmitting the random access response message according to the exemplary embodiment of the present invention.

FIG. 7 is a flowchart illustrating a method of receiving the random access response message according to the exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements. In addition, terms of “˜section”, “module”, and the like described in the specification mean a unit that processes at least one function or operation, which may be realized by software, hardware, or a combination of software and hardware.

In this specification, a terminal may designate a mobile station (MS), a mobile terminal (MT), a subscriber station (SS), a portable subscriber station (PSS), user equipment (UE), or an access terminal (AT), and may have all or some functions of the terminal, mobile terminal, subscriber station, portable subscriber station, user equipment, and access terminal.

In this specification, a base station (BS) may designate an access point (AP), a radio access station (RAS), a node-B, an eNB (evolved node-B) base transceiver station (BTS), or a mobile multihop relay (MMR)-BS, and may have all or some functions of the access point, radio access station, node-B, eNB BTS, and MMR-BS.

Hereinafter, a method of transmitting/receiving random access response information in a radio communication system and a base station and a terminal thereof according to exemplary embodiments of the present invention will be described in detail with reference to the accompanying drawings.

In a cellular system for packet service, terminals share radio resources for transmission of packet service data, unlike a circuit system in which the radio resources are dedicatedly allocated to terminals. Therefore, each terminal should be informed through control information by periods in which the radio resources are allocated so that each terminal can distinctively access and demodulate the radio resource allocated thereto.

The OFDMA technology is considered as the LTE (long term evolution; hereinafter referred to as “LTE”) of 3GPP which is currently under discussion. Unlike the CDMA technology for distinguishing between radio resources for terminals by code allocation, the OFDMA system has radio resources with a two-dimensional structure distinguished by frequency and time. That is, downlink and uplink physical channels separately transmit radio resources configured by time and frequency, and the radio resources use Transmission Time Interval (TTI) that is a transmission period and a radio resource block divided into sub-carrier groups.

Furthermore, a random access procedure may be divided into a contention scheme and a non-contention scheme in the LTE system of 3GPP.

The contention scheme is a random access procedure that is performed by terminals to which a terminal identifier (C-RNTI: cell radio network temporary identifier) is not allocated from a base station or by terminals to which a random access preamble sequence for a random access procedure is not allocated even if the terminal identifier has already been allocated.

In contrast, the non-contention scheme is a random access procedure that is capable of controlling and avoiding contention, which may occur during a random access procedure, by making a base station allocate a random access preamble sequence first transmitted from the terminal for the random access procedure. Such a non-contention-based random access procedure is targeted to terminals during handover or terminals that restart downlink data transmission.

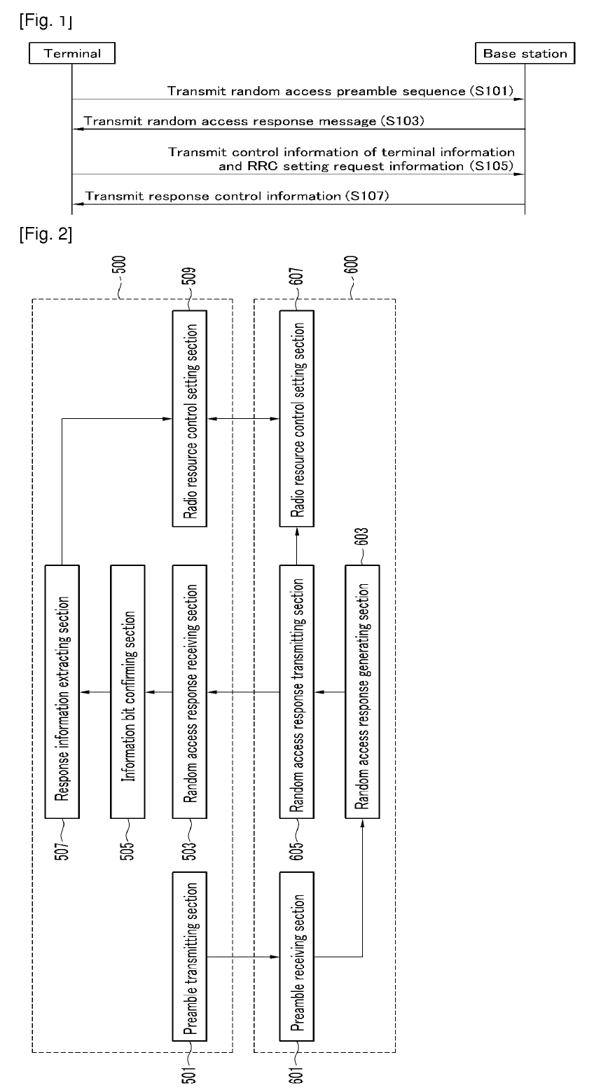

A typical contention-based random access procedure is defined so as to be configured as four stages, as shown in FIG. 1.

FIG. 1 is a flowchart illustrating a typical contention-based random access procedure to which the present invention is applied.

As shown in FIG. 1, the first step S101 is to transmit a random access preamble from the terminal to the base station. The random access preamble is configured by specially designed sequences, and the terminal randomly selects one among sets of sequences that are predetermined by the base station and then transmits the one selected set.

The second step S103 is to transmit a random access response message including the corresponding preamble sequence to the terminal when the base station detects the random access preamble transmitted from the terminal. Such a random access response message may include the following information. That is, the random access response message may include preamble sequences transmitted from the terminal, C-RNTI allocated to the terminal that has tried random access by the base station, uplink transmit time alignment information, uplink transmit power alignment information, and uplink radio resource allocation information.

In the third step S105, the terminal transmits its own information, for example, temporary mobile subscriber identity (TMSI) and/or radio resource control (RRC) connection establishment request information to the base station by using the uplink radio resource allocation information in the random access response message in the second step.

In the fourth step S107, response control information is transmitted to the terminal from the base station that has received the terminal information and/or the RRC setting request information from the terminal, to the terminal.

The random access response information is transmitted by using an identifier of C-RNTI, which is allocated beforehand for the random access response information, and a scheduling identifier that is an identifier used when the base station uniquely distinguishes between terminals within the base station. That is, the base station uses an identifier for transmission of random access response information, for example, a random access-radio network temporary identifier (RA-RNTI) for scheduling information for addressing the radio resource location of random access response information transmitted to a downlink shared channel (DL-SCH).

In the non-contention-based random access procedure, the base station specifies beforehand the random access preamble sequence to be transmitted from the terminal in the first step. In addition, the response information transmitted in the second step does not require information of “C-RNTI that is allocated from the base station to the terminal making an attempt to conduct the random access”, unlike the contention-based random access procedure.

Accordingly, the configuration and transmission method of the random access response message may be changed depending on a random access procedure method.

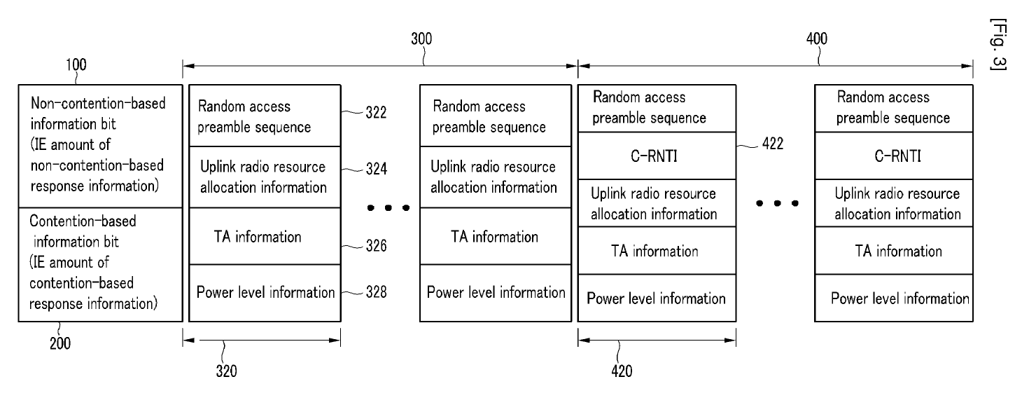

FIG. 2 is a block diagram illustrating the structures of terminal and base station that execute the random access procedure according to an exemplary embodiment of the invention.

As shown in FIG. 2, a terminal 500 includes a preamble transmitting section 501, a random access response receiving section 503, an information bit confirming section 505, a response information extracting section 507, and a radio resource control setting section 509.

A base station 600 includes a preamble receiving section 601, a random access response generating section 603, a random access response transmitting section 605, and a radio resource control setting section 607.

When the preamble transmitting section 501 of the terminal 500 transmits a random access preamble sequence, the preamble receiving section 601 of the base station 600 receives it. At this time, the random access preamble sequence may be one randomly selected from sets of contention-based random access preambles, which are provided beforehand from the base station 600 to the terminal 500. In addition, the random access preamble sequence may also be a specific non-contention random access preamble sequence allocated from the base station 600.

The random access response generating section 603 of the base station 600 generates non-contention-based random access response information or contention-based random access response information and transmits the generated random access response information to the terminal 500 through the random access response transmitting section 605.

That is, the random access response generating section 603 generates the random access response information according to whether to transmit non-contention-based response information and contention-based response information for one or more terminals that request the random access, by one radio resource.

In addition, the random access response transmitting section 605 transmits the random access response information, which is configured by at least one of the non-contention-based response information generated by the random access response generating section and the contention-based response information. Moreover, the random access response transmitting section 605 transmits the random access response information, which is configured by at least one of the non-contention-based response information or the contention-based response information.

The random access response receiving section 503 of the terminal 500 receives the random access response information from the random access response transmitting section 605 of the base station 600. That is, the random access response receiving section 503 of the terminal 500 receives the random access response information from the base station 600, and the random access response information includes an information bit indicating the scheme of response information and information on the response information included therein and at least one of response information.

The information bit confirming section 505 confirms a non-contention-based information bit or a contention-based information bit from the random access response information. That is, the information bit confirming section 505 confirms whether information bits received from the random access response receiving section 503 include both the non-contention-based information bit indicating the amount of non-contention-based response information and the contention-based information bit indicating the amount of contention-based response information, or whether the information bit received from the random access response receiving section 503 is one of the non-contention-based information bit and the contention-based information bit.

The response information extracting section 507 extracts the response information included in the random access response information of a confirmation result of the information bit confirming section 505. The response information included in the random access response information is extracted by using the information bit included in the random access response information. At this time, the random access response procedure is completed. That is, each of the radio resource control setting sections 509 and 607 in the terminal 500 and base station 600 sets a radio resource control by using the response information extracted by the response information extracting section 507 and completes the random access procedure.

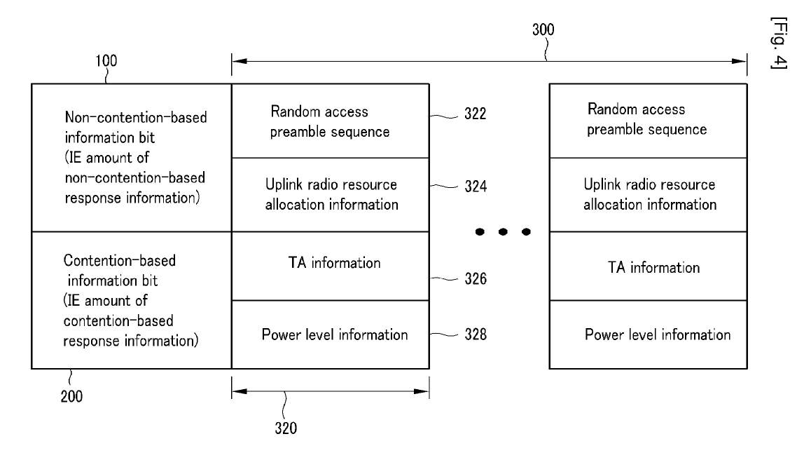

At this time, the random access response information has one of the format configurations shown in FIGS. 3, 4, and 5.

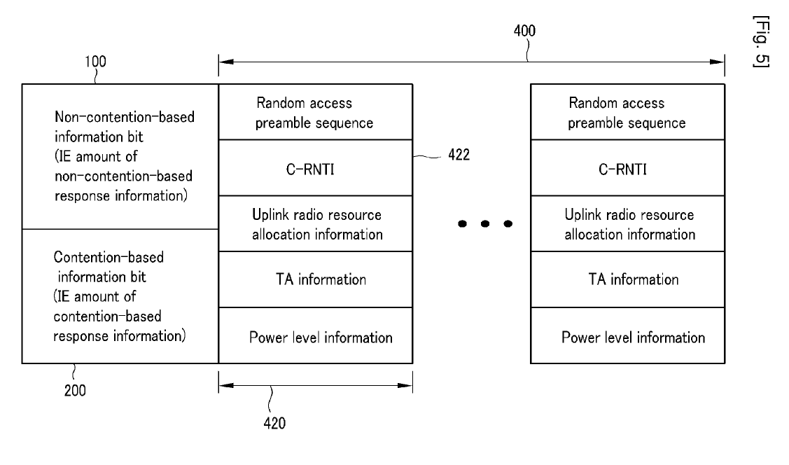

FIG. 3 illustrates the format configuration of the random access response message according to a first exemplary embodiment of the invention, and FIGS. 4 and 5 illustrate the format configurations of the random access response message according to a second exemplary embodiment of the invention.

FIG. 3 illustrates the format configuration when the non-contention-based response information and the contention-based response information are transmitted by one radio resource.

The random access response information includes a non-contention-based information bit 100 indicating the IE (information element; hereinafter, referred to as “IE”) amount of non-contention-based response information, a contention-based information bit 200 indicating the IE amount of contention-based response information, an interval 300 configured by at least one of non-contention-based response information, and an interval 400 configured by at least one of contention-based response information.

At this time, non-contention-based response information 320 includes a random access preamble sequence 322, uplink radio resource allocation information 324, TA information 326, and power level information 328.

In addition, the contention-based response information 420 has the same configuration as the non-contention-based response information 320 except for a radio network temporary identifier (C-RNTI) 422.

In this case, the same RA-RNTI is used in downlink scheduling information indicating a downlink radio resource that transmits the response information.

On the other hand, FIGS. 4 and 5 illustrate the format configurations when the non-contention-based response information and the contention-based response information are transmitted by separate radio resources.

In this case, the random access response information is transmitted by applying separate scheduling identifiers, that is, different RA-RNTI to non-contention-based response information and contention-based response information.

FIG. 4 shows the non-contention-based response information configured by a non-contention-based information bit 100, a contention-based information bit 200, and a section 300 including at least one of non-contention-based response information 320. At this time, the IE amount of contention-based response information in the contention-based information bit 200 indicates “0”.

FIG. 5 shows the contention-based response information configured by the non-contention-based information bit 100, the contention-based information bit 200, and the interval 400 including at least one of contention-based response information 420. At this time, the IE amount of non-contention-based response information in the non-contention-based information bit 100 indicates “0”.

Hereinafter, the random access procedure according to the exemplary embodiment of the invention will be described in detail with reference to FIGS. 4 and 5.

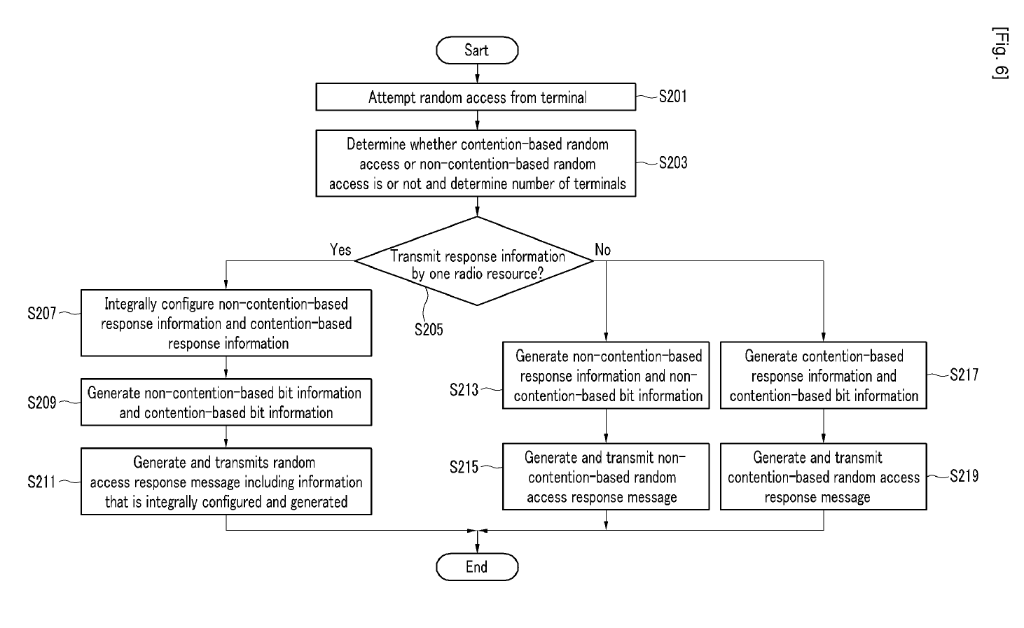

FIG. 6 is a flowchart illustrating a method of transmitting the random access response message according to the exemplary embodiment of the invention, which illustrates a process of transmitting the random access response message from the base station 600 to the terminal 500.

As shown in FIG. 6, the random access is attempted by the terminal (S201), and the base station determines whether the attempted random access is based on the contention or non-contention scheme and determines the number of terminals (S203). The base station 600 can determine whether the random access is based on the contention or non-contention scheme and can determine the number of terminals by detecting the random access preamble sequence received from the terminal that makes an attempt to conduct the random access.

Then, the base station 600 determines whether or not the contention-based response information or the non-contention-based response information is transmitted by one radio resource (S205). At this time, the base station 600 determines based on details of step S203 so as to efficiently configure the response information, from the point of view of allocation and utilization of radio resources.

When the base station 600 determines to transmit by one radio resource in step S205, the non-contention-based response information and contention-based response information are configured as shown in FIG. 3. That is, the non-contention-based response information and the contention-based response information are integrally configured (S207), and the non-contention-based information bit and the contention-based information bit are generated (S209). The base station transmits it by generating the random access response message composed of the generated non-contention-based information bit and contention-based information bit (S211).

When the base station 600 determines to transmit by separate radio resources in step S205, the non-contention-based response information, the non-contention-based information bit, the contention-based response information, and the contention-based information bit are generated, respectively (S213 and S217).

Then, the base station 600 transmits it by generating a non-contention-based random access response message that includes the information generated in step S213 (S215). In addition, the base station 600 transmits it by generating a contention-based random access response message that includes the information generated in step S217 (S219).

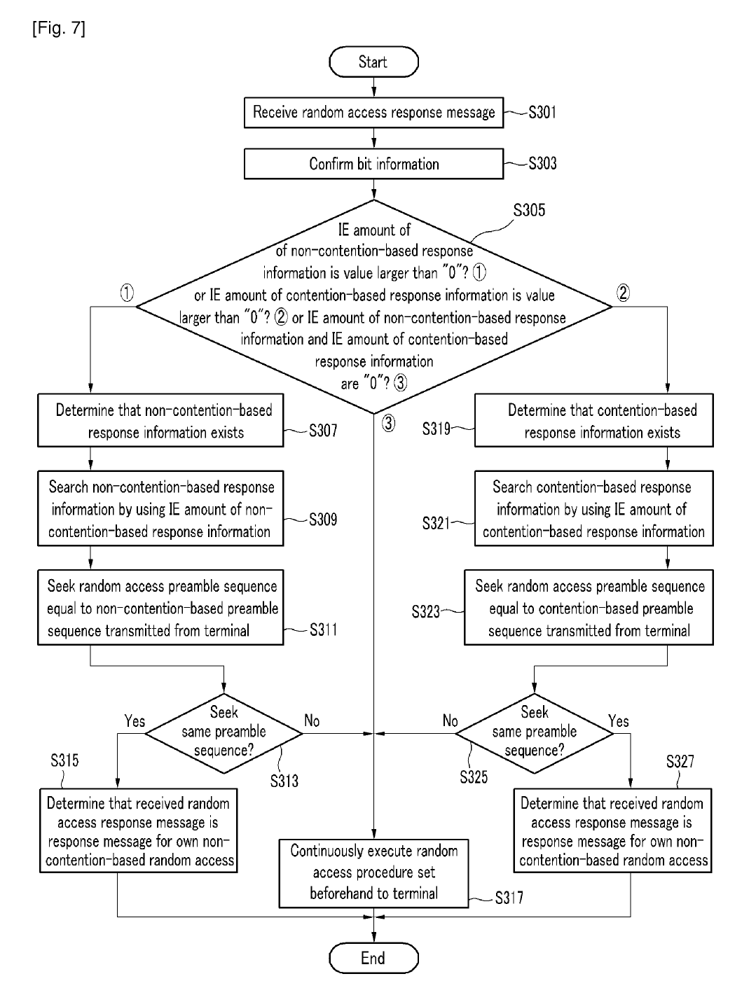

FIG. 7 is a flowchart illustrating a method of receiving the random access response message according to the exemplary embodiment of the invention, which illustrates a process where the terminal 500 receives the random access response message from the base station 600.

As shown in FIG. 7, the terminal 500 receives a random access response message from the base station 600 (S301). At this time, the terminal 500 first transmits a random access preamble sequence to the base station 600 according to the random access procedure. Then, the terminal 500 confirms downlink scheduling information transmitted to RA-RNTI by searching the downlink scheduling information and accesses the corresponding downlink radio resource to receive the random access response message.

The terminal 500 then confirms the non-contention-based information bit 100 and the contention-based information bit 200 located at the head of the random access response information (S303). The information bits 100 and 200 indicate the IE amount of non-contention-based response information and the IE amount of contention-based response information that exist in the random access response information, respectively.

By confirming the non-contention-based information bit 100 and the contention-based information bit 200, the terminal 500 determines whether the IE amount of non-contention-based response information is a value larger than “0”, whether the IE amount of contention-based response information is a value larger than “0”, or whether the IE number of non-contention-based response information and the IE amount of contention-based response information are “0” (S305).

As a result of determination in step S305, when the IE amount of non-contention-based response information is a value larger than “0”, the terminal 500 determines that the non-contention-based response information exists (S307). In this case, the response information exists about the terminal 500 that makes an attempt to conduct the non-contention-based random access by using the random access preamble sequence allocated beforehand according to the control of the base station 600.

At this time, if the terminal confirms that the IE amount of non-contention-based response information is “0” when the random access procedure is executed according to the non-contention-based random access procedure allocated beforehand to the terminal, the terminal can recognize in step S305 that the random access procedure fails. In contrast, if the terminal confirms that the IE amount of contention-based response information is “0” even when the contention-based random access procedure is executed, the terminal can recognize in step S305 that the random access procedure fails. Accordingly, when the terminal recognizes in step S305 that the random access fails, step S317 is executed by the terminal.

Meanwhile, the terminal 500 confirms in step S307 that the response information according to the non-contention-based random access procedure exists. Then, the terminal 500 searches the interval configured by the non-contention-based response information as many times as the IE amount of non-contention-based response information (S309), and seeks the random access preamble sequence in the non-contention-based response information that is equal to the non-contention-based random access preamble sequence transmitted by the terminal 500 (S311).

When the same preamble sequence is acquired through the seeking in step S311, the corresponding non-contention-based response information represents the response information on the non-contention-based random access of the terminal 500 (S315).

When the same preamble sequence is not acquired, the random access procedure is continued according to the predetermined method and procedures (S317).

Meanwhile, as a result of determination in step S305, when the IE amount of contention-based response information is a value larger than “0”, it determines that the contention-based response information exists (S319). This case is to try the contention-based random access by using the random access preamble sequence that is randomly selected by the terminal 500.

The terminal 500 searches the contention-based response information in the interval indicating the IE amount of contention-based response information, which exceeds the interval indicating the IE amount of non-contention-based response information (S321).

Then, the terminal 500 searches the contention-based response information having the same random access preamble sequence as the random access preamble sequence transmitted from the terminal 500 (S323).

When the same preamble sequence is searched in step S323, it is determined that the contention-based response information is response information on the contention-based random access of the terminal 500 (S325).

When the same preamble sequence is not searched, step S317 is executed by the terminal.

Although exemplary embodiments of the present invention have been described in detail, the scope of the present invention is not limited hereto. Various changes and modifications using the principle of the present invention as defined in the appended claims are also included in the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of transmitting random access response information by means of a base station, which transmits response information for random access processing requested from terminals to the base station in a radio communication system, comprising:
determining whether to transmit non-contention-based response information and contention-based response information for each of one or more terminals, which requests random access, by one radio resource;
transmitting the random access response information configured by the non-contention-based response information and the contention-based response information for each of one or more terminals, when determining to transmit by one radio resource in the determining; and
transmitting the random access response information configured by the non-contention-based response information or the contention-based response information for each of one or more terminals, when determining to transmit by separate radio resources in the determining.

2. The method of claim 1, wherein the determining is to determine whether to transmit the random access response information by one radio resource with reference to the contention-based random access or the non-contention-based random access of the terminals and the number of terminals, which request the random access, determined by detecting preambles of the terminals that request the random access.

3. The method of claim 2, wherein the random access response information includes an information bit indicating a non-contention-based or contention-based random access mode and the amount of response information included therein, and at least one of response information.

4. The method of claim 3, wherein the transmitting of the random access response information is to transmit each scheduling information by using different common scheduling identifiers for distinguishing radio resources for transmitting the random access response information, which is configured by the non-contention-based response information, and the random access response information, which is configured by the contention-based response information.

5. A method of receiving random access response information by means of terminals, which receives response information for random access processing requested from the terminals to a base station in a radio communication system, comprising:
receiving random access response information from the base station, the random access response information including an information bit, which indicates information on a mode of response information and the response information included therein, and at least one of the response information;
extracting response information included in the random access response information by using the information bit included in the random access response information; and
completing a random access response procedure by using the response information extracted from the random access response.

6. The method of claim 5, wherein the receiving of the random access response information is to receive random access response information including a non-contention-based information bit indicating the amount of non-contention-based response information and a contention-based information bit indicating the amount of contention-based response information.

7. The method of claim 5, wherein the receiving of the random access response information is to receive random access response information including one of a non-contention-based information bit indicating the amount of non-contention-based response information and a contention-based information bit indicating the amount of contention-based response information is received.

8. The method of claim 7, wherein the receiving of the random access response information is to separately receive random access response information configured by the non-contention-based response information and random access response information configured by the contention-based response information by using scheduling information composed of different common scheduling identifiers.

9. The method of claim 6, wherein the extracting of the response information comprises:
confirming whether non-contention-based response information or contention-based response information is included by using the non-contention-based information bit or the contention-based information bit included in the random access response information;
confirming an interval including the non-contention-based response information included in the random access response information by using the non-contention-based information bit, when the non-contention-based information bit indicates that the non-contention-based response information is included;
confirming an interval including the contention-based response information included in the random access response information by using the contention-based information bit, when the contention-based information bit indicates that the contention-based response information is included; and
extracting response information that has the same sequence as a random access preamble sequence transmitted from the terminals to the base station by searching each of the confirmed intervals.

10. A base station that transmits response information for random access processing requested from terminals in a radio communication system, comprising:
a random access response generating section that generates random access response information according to whether to transmit non-contention-based response information and contention-based response information for each one or more terminals, which requests random access, by one radio resource; and
a random access response transmitting section that transmits random access response information configured by at least one of non-contention-based response information and at least one of contention-based response information, which are generated by the random access response generating section, or that transmits random access response information configured by at least one of non-contention-based response information or at least one of contention-based response information.

11. The base station of claim 10, wherein the random access response generating section determines whether to transmit the non-contention-based response information and the contention-based response information by one radio resource with reference to the contention-based random access or the non-contention-based random access of the terminals and the number of terminals, which request the random access, determined by detecting preambles of the terminals that request the random access.

12. The base station of claim 11, wherein the random access response generating section generates a random access response including a non-contention-based information bit that indicates a non-contention scheme and the amount of non-contention-based response information and a contention-based information bit that indicates a contention scheme and the amount of contention-based response information, when determining to transmit by one radio resource, and generates a random access response including non-contention-based information bit or contention-based information bit, when determining to be transmitted by different radio resources.

13. The base station of claim 12, wherein the random access response transmitting section transmits each scheduling information by using different common scheduling identifiers for distinguishing the radio resources that transmit the random access response information configured by the non-contention-based response information and the random access response information configured by the contention-based response information, respectively.

14. A terminal that receives response information for random access processing requested to a base station in a radio communication system, comprising:
a random access response receiving section that receives random access response information including an information bit, which indicates information on a mode of response information and the response information included therein, and at least one of the response information from the base station; and
a response information extracting section that extracts response information included in the random access response information by using the information bit included in the random access response information and completes a random access response procedure.

15. The terminal of claim 14, further comprising an information bit confirming section that confirms whether the information bit received through the random access response receiving section includes both a non-contention-based information bit indicating the amount of non-contention-based response information and a contention-based information bit indicating the amount of contention-based response information or whether the information bit is one of the non-contention-based information bit and the contention-based information bit.

16. The terminal of claim 15, wherein the information bit confirming section confirms whether the non-contention-based information bit indicates that the non-contention-based response information is included or whether the contention-based information bit indicates that the contention-based response information is included.

17. The terminal of claim 16, wherein, on the basis of a confirmation result of the information bit confirming section, the response information extracting section confirms an interval including the non-contention-based response information included in the random access response information by using the non-contention-based information bit, when the non-contention-based information bit indicates that the non-contention-based response information is included, confirms an interval including the contention-based response information included in the random access response information by using the contention-based information bit, when the contention-based information bit indicates that the contention-based response information is included, and extracts from each interval response information that has the same sequence as a random access preamble sequence transmitted from the terminals to the base station.
